(19) United States
(12) Patent Application Publication
(10) Pub. No.: US 2006/0154766 A1
(43) Pub. Date: Jul. 13, 2006

(54) Belt drive system

(76) Inventors: Fraser Lacy, Aachen (DE); Richard Anthony Cherry, Dumfries (GB); John W. Black, Dumfriesshire (GB)

Correspondence Address: Jeffrey Thurnau;The Gates Corporation, IP Law Dept. 10-A3, 1551 Wewatta Street, Denver, CO, 80202, US

(21) Appl. No.: 11/032,640

(22) Filed: Jan. 10, 2005

(51) Int. Cl. F16H 7/12; F16H 7/00; F16H 55/36

(52) U.S. Cl. 474/148; 474/237; 474/166

(57) ABSTRACT

A belt drive system having a belt having a belt body. A tensile cord disposed in the belt body running along a longitudinal axis. A plurality of belt teeth disposed on an outer surface of the belt body, the belt teeth oriented transverse to the longitudinal axis. A belt land disposed between the belt teeth. A driver sprocket attached to an engine crankshaft, the engine having a plurality of cylinders. A driven sprocket. The number of grooves on the driver sprocket being an integer multiple of the number of engine cylinders divided by two. The number of grooves on the driven sprocket being an integer multiple of the number of grooves in the driver sprocket. The number of belt teeth, land length and sprocket groove spacing is dependent on the number of engine firing events per crankshaft revolution thereby reducing the frequency of the belt/pulley meshing to a level within the orders of engine frequencies.

### FIELD OF THE INVENTION

The invention relates to a belt drive system, and more particularly to a belt drive system comprising a belt and cooperating sprocket in which the number of belt teeth, land length and sprocket groove spacing is dependent on the number of engine firing events per crankshaft revolution thereby reducing the frequency and noise by having the belt/pulley meshing frequency the same as an engine firing order.

### BACKGROUND OF THE INVENTION

Synchronous belts, or toothed belts, are used in belt driven power transmission systems were it is necessary to synchronize driven components. Synchronization is achieved by the interaction of transverse teeth disposed on the belt with grooves in a driver and driven sprocket. Meshing of the teeth with the respective grooves serves to mechanically coordinate rotation of the sprockets and thereby the driven equipment.

Synchronous belts comprise a plurality of transversely mounted teeth arranged adjacent to each other along the length of the belt. Power transmission occurs at the point of engagement of each tooth with the sprocket in a plane substantially tangent to the sprocket at the point of engagement. Hence, the teeth are in shear for the most part. The area between each set of teeth is referred to as the land.

Synchronous belts are also known that have a greater relative land area or spacing between teeth. Such belts rely in part on the frictional interaction of the land with the sprocket periphery to transmit torque. The torque transmitting capability is a function of the belt wrap angle about the sprocket, installation tension and the coefficient of friction of the belt surface.

Representative of the art is U.S. Pat. No. 4,047,444 (1977) to Jeffrey which discloses a synchronous belt and sprocket drive in which the drive between spaced sprockets is primarily by frictional contact of a belt on the sprocket peripheries.

The prior art relies solely on having a differential groove spacing between the driver and driven sprockets which is based in part on differing belt tensions. The problem of reducing operating harmonics and noise is not addressed or solved by the prior art.

What is needed is a belt drive system to provide a belt and cooperating sprocket in which the number of belt teeth, land length and sprocket groove spacing is dependent on the number of engine firing events per crankshaft revolution thereby reducing the frequency of belt/pulley meshing to a level indistinguishable from engine frequency orders. The present invention meets this need.

### SUMMARY OF THE INVENTION

The primary aspect of the invention is to provide a belt and cooperating sprocket in which the number of belt teeth, land length and sprocket groove spacing is dependent on the number of engine firing events per crankshaft revolution thereby reducing the frequency of belt/pulley meshing to a level indistinguishable from engine frequency orders.

Other aspects of the invention will be pointed out or made obvious by the following description of the invention and the accompanying drawings.

The invention comprises a belt drive system having a belt having a belt body. A tensile cord disposed in the belt body running along a longitudinal axis. A plurality of belt teeth disposed on an outer surface of the belt body, the belt teeth oriented transverse to the longitudinal axis. A belt land is disposed between the belt teeth. A driver sprocket attached to an engine crankshaft, the engine having a plurality of cylinders. A driven sprocket. The number of grooves on the driver sprocket being an integer multiple of the number of engine cylinders divided by two. The number of grooves on the driven sprocket being an integer multiple of the number of grooves in the driver sprocket. The number of belt teeth, land length and sprocket groove spacing is dependent on the number of engine firing events per crankshaft revolution thereby reducing the frequency of the belt/pulley meshing to a level within the orders of engine frequencies.

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1 is a schematic diagram of a prior art system.

FIG. 2 is a side view of an inventive belt and sprocket FIG. 3 is a side view of a sprocket groove.

FIG. 4 is a side view of a sprocket groove.

FIG. 5 is a side view of an inventive belt.

FIG. 6 is a side view of an inventive belt.

FIG. 7 is a graph showing angular vibration versus installation tension using the inventive system.

FIG. 8 is a graph showing effective tension versus installation tension using the inventive system.

FIG. 9 is a graph comparing 19^{th} order harmonics.

FIG. 10 is a graph comparing 8^{th} order harmonics.

FIG. 11 is a perspective view of a prior art belt showing tooth and land lengths.

FIG. 12 is a perspective view of an inventive belt showing tooth and land lengths.

FIG. 13 is a perspective view of an inventive belt showing tooth and land lengths.

FIG. 14 is a partial perspective view of a sprocket for engaging the belt in FIG. 13.

### DETAILED DESCRIPTION OF THE PREFERRED EMBODIMENT

Synchronous belt drive systems are widely used in automotive engine applications to drive camshafts and other devices such as fuel pumps, water pumps, alternators and so on.

On some engines, the magnitude of the angular vibrations of one or more of the driven components necessitates the inclusion of a torsional damping device. Use of a damping device adds cost, complexity and weight to the engine.

The present invention enables the elimination of such damping devices, in some cases, by increasing the belt drive system stiffness through changes in installation tension, modulus increase and belt tooth/pulley interface interaction without detriment to the belt life or increased system noise.

Increasing the system tension with conventionally toothed belts can result in an increase in belt land wear due to higher contact pressures between the belt land and sprocket, as well as increases in system noise due to higher belt/sprocket impact.

The present invention avoids the increase in belt land wear by incorporating significant spacing between the teeth, denoted as pitch P see FIG. 5, which reduces the pressure per unit area exerted by tension forces on the belt land. The inventive configuration results in a larger than normal pitch P, which in turn results in fewer teeth on the belt available to carry a torque load for a given belt length. However, the inventive belt and system compensates for this by optimization of the belt tooth profile and by allowing the land area between the teeth to carry a significant proportion of the torque load. Further, the present invention avoids any increase in noise associated with high belt tensions by reducing the frequency of the belt vibrations and harmonic orders and by having a belt tooth and driver sprocket groove meshing frequency superimposed upon an engine cylinder firing timing frequency which significantly reduces predetermined and undesirable belt vibration harmonic orders.

A significant portion of the transmitted load is borne by the belt land. Therefore, power transmission by the flat belt land relies on Euler's flat belt formula which describes the behavior of the belt as it is transmitting torque.

In an operating condition, the belt is under tension between a driver and driven sprocket. The tension in a belt entering a sprocket (T₁) is different than the tension of the belt as it exits the sprocket (T₂) . For a flat belt using Euler's theory the equation relating belt tensions T₁ and T₂ to the coefficient of friction (μ) and the angle of belt wrap (θ) in radians is:
T₁=T₂ e^{μθ}

where e is the base of natural logarithms, 2.718, T₁ is the tight side tension and T₂ is the slack side tension. Impending slip is the upper limit of the frictional power transmitting capability of the belt.

[image]

This graph indicates the approximate limiting ratio for T₁/T₂ for θ=180° of belt wrap as a function of the coefficient of friction between a flat belt and a sprocket.

Assuming a Coefficient of Friction = 0.35

| | T2 = Tinst | T1 | T1 − T2 = Te |
|---|---|---|---|
| T1/T2 | (N) | (N) | (N) |
| 3 | 250 | 750 | 500 |
| 3 | 500 | 1500 | 1000 |
| 3 | 750 | 2250 | 1500 |

Referring to the foregoing table, using this theory it is possible to transmit solely by friction an effective tension level (Tₑ) of approximately 1500 newtons with T₂=750N and a coefficient of friction (μ) of approximately 0.35. Effective tension is defined as the difference between the belt tight side tension and the belt slack side tension. Slack side tension is a function the installation tension (Tᵢₙₛₜ). Tight side tension is a function of the load being carried by the drive (T₁).

If T₁/T₂ is less than or equal to e^{μθ} the belt will not slip on the sprocket. For ratios larger than this, that is T₁/T₂ greater than e^{μθ}, slipping will occur.

However, in all cases the belt will creep on the sprockets. Consider a piece of belt of unit length moving onto a f first sprocket under tension T₁. As this piece of belt of unit length moves around with the sprocket the tension to which it is subjected decreases from T₁ to T₂. Due to its elasticity the belt piece slightly shrinks in length. Therefore, the first (driver) sprocket continually receives a greater length of belt than it delivers and the velocity of the sprocket surface is greater than t hat of the belt moving over it. Similarly, a second ( driven) sprocket receives a lesser length of belt than it delivers, and its surface velocity is less than that of the belt moving over it. This “creeping” of the belt as it moves over the sprockets results in some unavoidable loss of power which diminishes efficiency.

As the value of T₁ approaches that of T2, namely (T₁/T₂→1), the amount of creep will diminish because there is less change in the length of a unit piece of belt moving over the sprocket. When T₁=T₂, we have the “as installed” condition and no power can be transmitted by the system.

The coefficient of friction for the belt land is approximately 0.35 for the foregoing non-limiting examples. The range of sufficient coefficients of friction (μ) for the belt land (110) is approximately 0.30 to approximately 0.40.

For a synchronous belt drive, the foregoing flat belt theory is limited by the interaction of the belt teeth with the sprocket grooves. Transmission of power is achieved by sharing the load between belt tooth load and frictional effects. In current practice, the majority of this load is carried by the belt teeth.

The tooth profile is optimized dimensionally and geometrically for load carrying and belt-sprocket meshing. For example, the tooth profile may be that disclosed in U.S. Pat. No. 4,605,389 which is incorporated herein in its entirety by reference. U.S. Pat. No. 4,605,389 is cited as an example profile and is not intended to operate as a limitation on the types of profiles that may be used in this invention.

As noted the inventive belt maximizes the length of the belt land and thereby of the contact area between the belt land and the sprocket periphery while maintaining the synchronous attributes of a toothed belt. The system further provides non-interference between the tip of each belt tooth and the bottom or root of each cooperating sprocket groove to ensure pressure is maintained in the contact area between each belt land and cooperating sprocket surface portion.

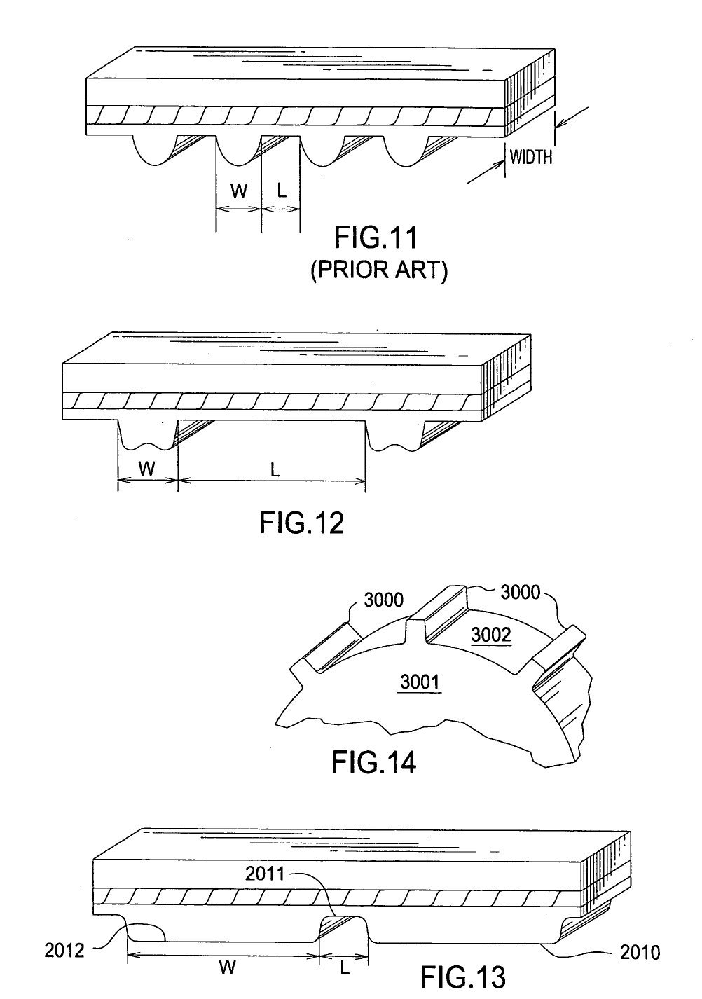

The ratio of land area to tooth area for prior art belts having a standard pitch is approximately 0.50:1, see FIG. 11. Referring to FIG. 5, FIG. 6, and FIGS. 11-13, the tooth area is the plan area of the belt occupied by the tooth, namely, tooth length (W) multiplied by the width of the belt. The land area is the plan area of the belt occupied by the land, namely, land length L multiplied by the width of the belt. The width of the belt is known in the art and corresponds to standard industry widths. The inventive belt has a land area to tooth area ratio in the range of approximately 1.5:1.0 up to approximately 10.0:1.0, see FIG. 12.

In an alternate embodiment, referring to FIG. 13, the land area to tooth area ratio is inverted, meaning, the ratio of land area to tooth area is in the range of approximately 0.20:1.0 to approximately 0.09:1.0. Hence, this alternate embodiment ratio describes a belt wherein the tooth area is significantly greater than the land area. In this case power is transmitted through friction between the bottom of pulley groove 3002 and the top 2012 of the tooth 2010, see FIG. 14. Hence, in this case, the belt tooth depth is deeper than the pulley groove depth, and there is clearance between the top of pulley tooth 3000 and the belt in the land area 2011, to ensure contact between surface 2012 and 3002 for load carrying purposes. FIG. 14 is a partial perspective view of a sprocket for engaging the belt in FIG. 13. Sprocket 3001 comprises pulley groove surface 3002 which frictionally engages a tooth top surface 2012. It is through this frictional engagement that power is transmitted by this alternate embodiment. Sprocket tooth 3000 engages a belt groove area 2011 between teeth 2010 to maintain synchronization. All other aspects of the belt construction are as disclosed elsewhere in this specification for the other embodiments.

Turning back to belt construction, the belt materials further comprise a facing material used in a jacket layer 106 having a high coefficient of friction, see FIG. 5. The jacket layer may comprise texturised or non-texturised woven or texturised or non-texturised unwoven fabric containing yarns of aramid, polyamide, PTFE, PBO, polyester carbon, or other synthetic fiber or combinations of two or more of the foregoing. These may be applied as a continuous layer, may be incorporated in the rubber compound material or may be applied in the design of the tensile member.

The jacket layer facing material may be treated with solvent based polymeric adhesives or aqueous based resorcin formalin latex (RFL) system containing any grade of HNBR, any grade of CR, sulphinated polyethylene or EPDM. These are used to maximize abrasion resistance, to maximize heat resistance and resistance to heat aging and to ensure high adhesion levels between this facing material and other belt components at all temperature levels over the drive system lifetime. The overall result is a belt that maximizes the ability of the belt land to carry a significant level of load by utilizing the flat belt drive theory stated above.

Referring again to FIG. 5, the belt further comprises high modulus tensile members 107 disposed parallel to a longitudinal axis which extends in an endless direction. The tensile members can comprise twisted, or twisted and plied yarns containing fiberglass, high strength glass, PBO, aramid, wire or carbon or combinations thereof. The tensile cord may be applied as a single core forming a helix across the width of the belt, or applied in pairs of tensile cords with alternative twist directions (Z and S) forming a helix across the width of the belt. The tensile cords may also be treated with solvent based polymeric adhesives or aqueous based RFL systems, including VPCSM/VPSBR/HNBR/CR in the RFL. They may contain any grade of HNBR, any grade of CR, sulphinated polyethylene or EPDM along with sizing agent. These agents ensure high adhesion levels between the tensile member and other belt elastomeric components at all temperature levels over the drive system lifetime. They also minimize tensile strength degradation caused by flex fatigue and inter-filament abrasion, where relevant, over the life time of the drive. They also minimize tensile strength degradation caused by low temperature conditions while maximizing fluid resistance of the tensile member over the life time of the belt.

The belt body 108 comprises a high modulus elastomeric compound based on any grade of HNBR, CR, EPDM, SBR and polyurethane or any combination of two or more of the foregoing.

The belt body may optionally include discontinuous fibers for a fiber loading, which may be utilized to augment the modulus of the resulting compound. The type of fibers 40, 400, see FIGS. 5, 6 that may beneficially be used as a reinforcement of the belt elastomer include meta-aramids, para-aramids, polyester, polyamide, cotton, rayon and glass, as well as combinations of two or more of the foregoing, but is preferably para-aramid. The fibers may be fibrillated or pulped, as is well known in the art, where possible for a given fiber type, to increase their surface area, or they may be chopped or in the form of a staple fiber, as is similarly well known in the art. For purposes of the present disclosure, the terms “fibrillated” and “pulped” shall be used interchangeably to indicate this known characteristic, and the terms, “chopped” or “staple” will be used interchangeably to indicate the distinct, known characteristic. The fibers 40 preferably have a length from about 0.1 to about 10 mm. The fibers may optionally be treated as desired based in part on the fiber type to improve their adhesion to the elastomer. An example of a fiber treatment is any suitable Resorcinol Formaldehyde Latex (RFL).

In a preferred embodiment wherein the fibers are of the staple or chopped variety, the fibers may be formed of a polyamide, rayon or glass, and have an aspect ratio or “L/D” (ratio of fiber length to diameter) preferably equal to 10 or greater. In addition, the fibers preferably have a length from about 0.1 to about 5 mm.

In another preferred embodiment wherein the fibers are of the pulped or fibrillated variety, the fibers are preferably formed of para-aramid, and possess a specific surface area of from about 1 m.sup.2 /g to about 15 m.sup.2 /g, more preferably of about 3 m.sup.2 /g to about 12 m.sup.2 /g, most preferably from about 6 m.sup.2 /g to about 8 m.sup.2 /g; and/or an average fiber length of from about 0.1 mm to about 5.0 mm, more preferably of from about 0.3 mm to about 3.5 mm, and most preferably of from about 0.5 mm to about 2.0 mm.

The amount of para-aramid fibrillated fiber used in a preferred embodiment of the invention may beneficially be from about 0.5 to about 20 parts per hundred weight of nitrile rubber; is preferably from about 0.9 to about 10.0 parts per hundred weight of nitrile rubber, more preferably from about 1.0 to about 5.0 parts per hundred weight of nitrile rubber, and is most preferably from about 2.0 to about 4.0 parts per hundred weight of nitrile rubber. One skilled in the relevant art would recognize that at higher fiber loading concentrations, the elastomer would preferably be modified to include additional materials, e.g. plasticizers, to prevent excessive hardness of the cured elastomer.

The fibers may be randomly dispersed throughout the elastomeric material in the power transmission belt or may be oriented in any desired direction. It is also possible, and is preferable for toothed belts fabricated in accordance with the present invention, that the fibers are oriented throughout the elastomeric material in the power transmission belt, as illustrated for example in FIG. 13.

The fibers 40, 400 in the teeth 104, 105, 201 are preferably oriented longitudinally, in the run direction of the belt. But the fibers 40, 400 in the teeth 104, 105, 201 are not all parallel to the tensile cords 107, 203; the fibers 40, 400 in the teeth are arranged longitudinally, yet follow the flow direction of the elastomeric material during tooth formation when formed according to the flow-through method. This results in the fibers 40, 400 being oriented in the belt teeth 104, 105, 201 in a longitudinal, generally sinusoidal pattern, which matches the profile of the teeth.

When oriented in this preferred configuration, such that the direction of fibers is generally in the run direction of the toothed belt, it has been found that the fibers 40, 400 located in the belt's back surface section 120, 1200 inhibit the propagation of cracks in the belt's back surface, particularly those caused by operation at excessively high or low temperature, which otherwise generally propagate in a direction perpendicular to the run direction of the belt. However, it is to be understood that the fibers 40, 400 need not be oriented or may be oriented in a different direction or directions than illustrated.

The application of the described design principles are described in the following example.

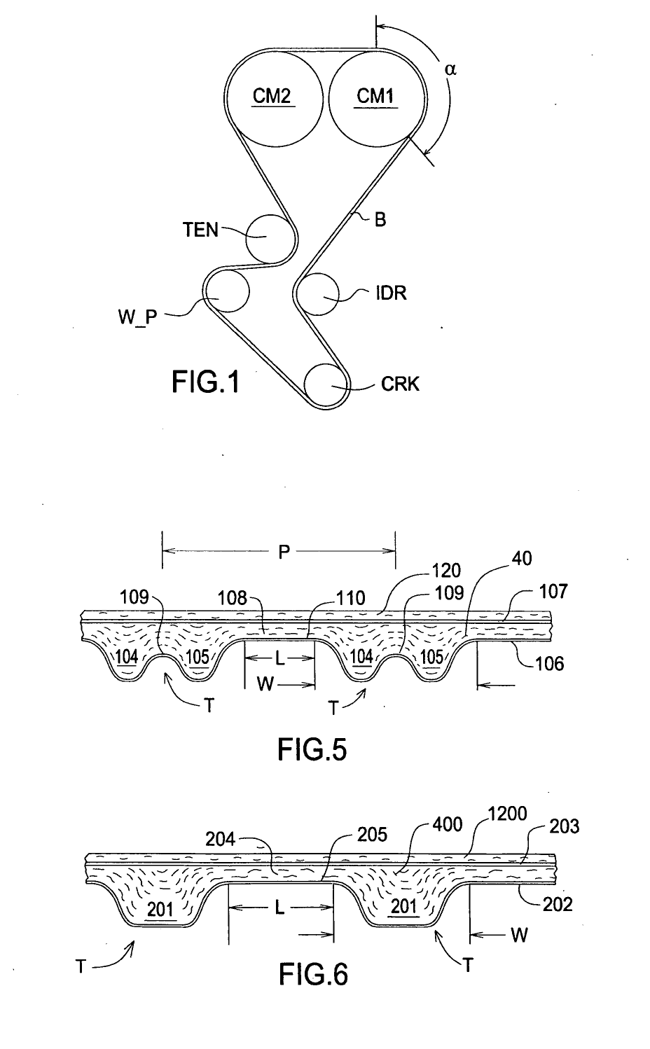

Referring to FIG. 1, a prior art system has the following specifications. A toothed belt (B) has 135 teeth and a 9.525 mm pitch (P). The drive length is 1285.875 mm. The sprockets are as follows:
19 grooves crankshaft sprocket (CRK)
18 grooves water pump sprocket (W_P)
38 grooves camshafts sprocket (CM1, CM2)
4 engine cylinders
   The camshaft sprockets (CM1, CM2) have a diameter of 113.84 mm. TEN and IDR denote a tensioner and idler respectively, each known in the art.

Referring again to FIG. 1, the inventive belt and system which replaces the foregoing prior art system is designed so that the drive length remains the same and the sprocket diameters are not exceeded.

The inventive system incorporates a pitch (P) which is dependant in part on the overall drive length of the belt. The crankshaft sprocket number of grooves is dependant on the number of firing events of the engine in one crankshaft revolution. The tooth shear area width to land area length ratio is dependant on the pitch (P).

The inventive belt (B) has an integer number of teeth disposed transverse to the longitudinal axis, in this case 57 teeth, as opposed to 135 teeth for the prior art belt. In this example the belt pitch (P) is 22.62 mm as compared to 9.525 mm for the prior art system. The crankshaft sprocket (CRK) (driver sprocket) has an integer number of grooves which is an integer multiple of the number of engine cylinders divided by two, in this case 8 grooves are selected (4 engine cylinders×2). The camshaft sprockets (CM1, CM2) each have 2 times the number of grooves in the crankshaft sprocket (8 grooves), which in this case gives 16 grooves in each camshaft sprocket. The water pump sprocket (W_P) number of grooves is also an integer, in this case 8 grooves. If necessary, for different belt constructions the belt pitch (P) can be adjusted to give a desired tensioner arm position.

For improved noise performance, the number of grooves in the crankshaft sprocket is an integer multiple of the number of engine cylinders divided by two. This relates the number of crankshaft sprocket grooves to the number of engine cylinder firing events per crankshaft revolution. In this way, the belt/sprocket meshing frequency is significantly reduced and therefore the meshing noise is rendered indistinct from other engine frequency order noises.

Although the above four cylinder engine example has 8 grooves in crankshaft sprocket, the crankshaft sprocket may also comprise any integer multiple of the number of engine cylinders divided by two, for example, 4 or 12 grooves.

In operation each belt tooth serially engages a driver sprocket groove and driven sprocket groove in order to maintain proper synchronization of the driven accessories. The system requires least two belt teeth to be engaged with driver sprocket grooves and two belt teeth to be engaged with driven sprocket grooves at all times to maintain proper synchronization. The number of teeth, and more particularly the pitch, is directly related to the angle of wrap (α). That is, as the angle of wrap decreases the belt tooth spacing and sprocket groove spacing must decrease to assure at least two belt teeth are in contact with corresponding sprocket grooves at all times. At the limit the tooth pitch (P) is:
P≦(π/180°)*(r)*(a)

Were

r=the radius of the smallest sprocket pitch diameter

α=angle of wrap of the belt about the smallest sprocket

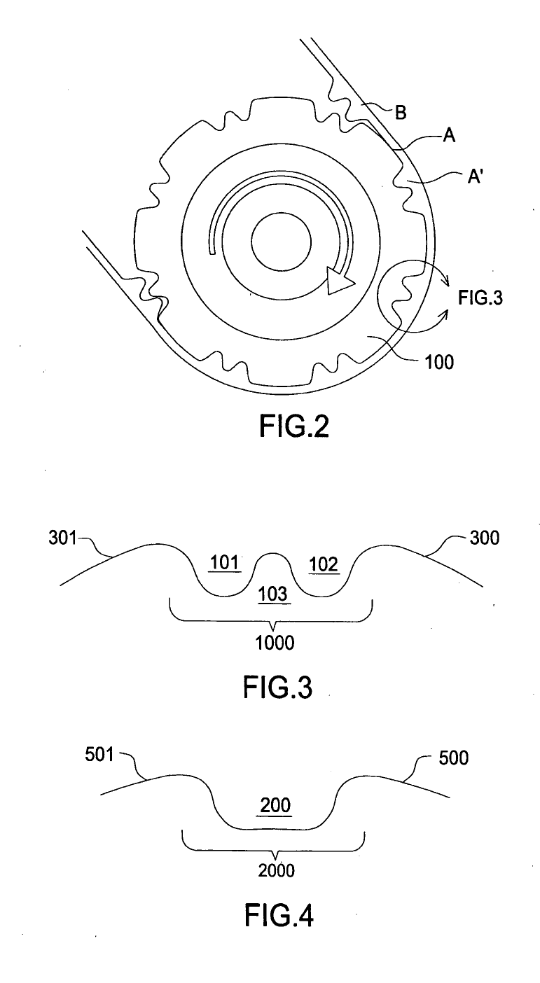

Turning now to FIG. 2 which is a side view of an inventive sprocket and belt, the position marked (A) represents the belt tight side span tangent point on a belt land at maximum load. Position (A) is where the belt engages the driver sprocket. Belt B is shown engaged with driver sprocket 100 driving in the direction depicted by the arrow. Power, i.e., torque, is transmitted to the driven pulley by frictional contact between the belt land surface and the pulley periphery.

Crankshaft sprocket 100 comprises 8 grooves for engaging the belt. Point (A) represents the belt-sprocket position when a cylinder firing event occurs. Regarding position (A), at least approximately 50% between point (A) where the belt engages the driver sprocket and the first immediately engaged belt tooth (A′) at least 50% of the belt land is in contact with the sprocket at each cylinder firing event. Engine timing may be adjusted so that point (A) results in up to 100% of the land area between point (A) and the first immediately engaged tooth (A′) on the tight belt side being engaged upon each cylinder firing event.

This method of drive timing minimizes tooth shear loading caused by each engine firing event, that is, a maximum portion of the land is engaged with the sprocket during an engine firing event to maximize the land frictional contribution with the tooth shear capacity during power transmission. Hence, tooth meshing is primarily used to ensure proper synchronization. The power or torque is transmitted primarily by engagement of the belt land with the cooperating surface on the sprocket.

FIG. 3 is a profile of a sprocket groove. Each groove 1000 in turn comprises a first groove 101 and a second groove 102. A tooth 103 is disposed between each pair of grooves 101, 102. Groove 1000 meshes with a cooperating belt profile described in FIG. 5, that is, teeth 104, 105 cooperatively engage grooves 101, 102 respectively. Land areas 300, 301 engage belt land area 110.

FIG. 4 is a profile of a sprocket groove. In this example, groove 2000 comprises a single groove 200. Groove 200 meshes with a belt tooth 201 as shown in FIG. 6. Land areas 500, 501 engage belt land areas 205.

FIG. 5 is a cross-sectional view of a belt. The belt comprises tooth portions 104 and 105 disposed in a belt body 108. A dimple or groove 109 is disposed between tooth portions 104 and 105. Tooth portions 104 and 105 in combination with dimple 109 comprise a single tooth T for the purposes of this disclosure. Tooth T has a length W. Disposed between each tooth T is a land area 110 having a length L. In the inventive belt land area 110 has a length L greater than a tooth length width W. Pitch P is the spacing between corresponding points of consecutive teeth. Optionally, the dimple 109 may be omitted from the tooth shape, see FIG. 6, with the cooperating tooth 103 likewise omitted from the sprocket.

Tensile cord 107 is disposed along a longitudinal axis of the belt. The longitudinal axis runs in an endless direction. Jacket layer 106 is disposed on a sprocket engaging surface of the belt.

FIG. 6 is a cross-sectional view of a belt. The belt comprises teeth 201 disposed in a belt body 204. A tensile cord 204 is disposed along a longitudinal axis of the belt. The longitudinal axis runs in an endless direction. Jacket layer 202 is disposed on a sprocket engaging surface of the belt. Tooth 201 has a length W. Disposed between each tooth 201 is a land area 205 having a length L. In the inventive belt land area 205 has a length L equal to or greater than a tooth length W.

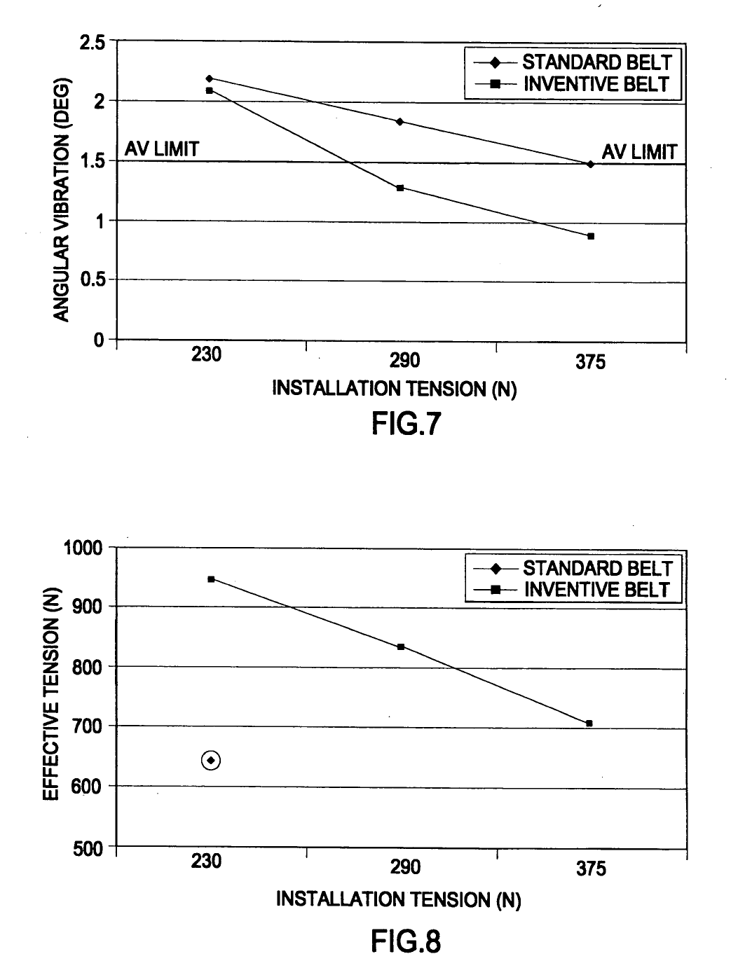

The inventive system provides a number of improvements over prior art systems. FIG. 7 is a chart depicting the reduction of the angular vibration (AV) of an engine camshaft as a function of belt installation tension without the need for a cam damper mechanism. One can see that by use of the inventive belt and sprocket, angular vibration is significantly reduced from 2.2° to 0.9°. It is preferable that angular vibration in a system be less than 1.5° to minimize belt and system wear. Hence the invention allows for a reduction in system complexity and cost through deletion of cam dampers.

The vibration amplitude of the belt tight side span during operation is reduced by approximately 30% using the inventive belt. The speed at which resonance occurs in the belt tight side span increases from approximately 2000 RPM to 3000 RPM.

Referring to FIG. 8, the effective tension (Tₑ) is reduced as the installation tension (Tᵢₙₛₜ) in increased from 230N for the prior art to 375N for the inventive system. For prior art systems this tension increase would result in reduced life and increased noise. This is not the case for the inventive system as per the foregoing reasons.

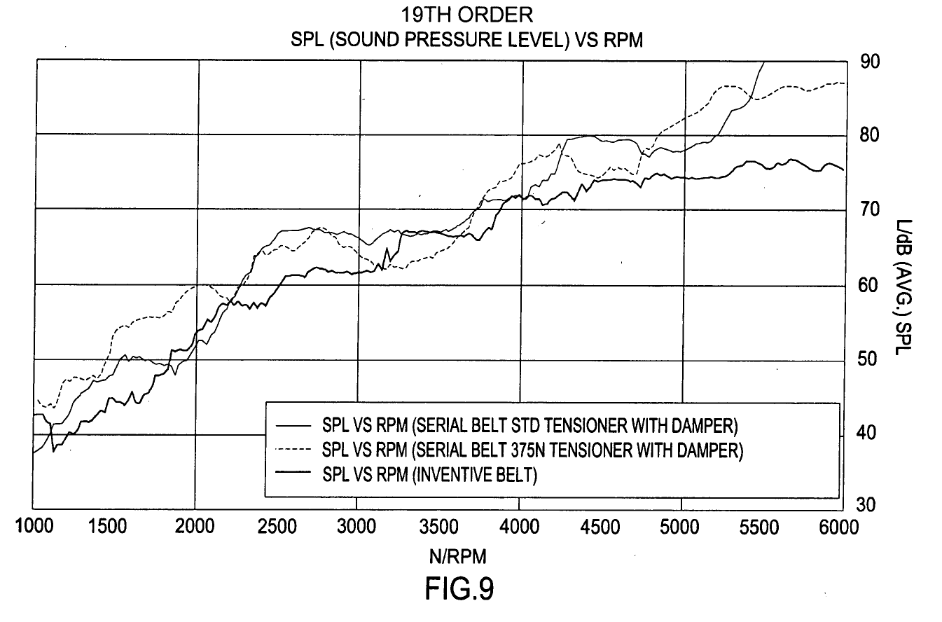

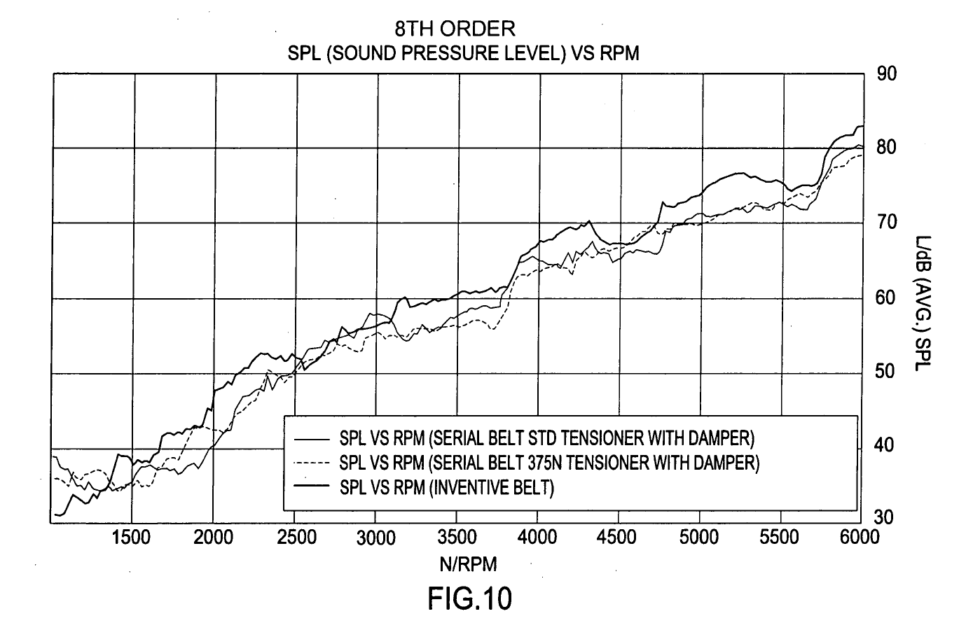

With respect to noise generated by the system, the inventive system significantly reduces the 19^{th} order and related harmonic frequencies, see FIG. 9, which are associated with distinctive noise caused by belt/sprocket meshing for prior art systems. Additional 8^{th} order and related harmonic frequencies, see FIG. 10, are introduced but these occur at the same frequency as other engine orders such as firing order. In each of FIG. 9 and FIG. 10 the inventive system is installed at an effective tension of 375 newtons without a damper. On the other hand, the other systems each include a damper, which represents additional system cost. The inventive system reduces the frequency of vibrations caused by belt/pulley meshing to a level indistinguishable from engine frequency orders.

Although forms of the invention have been described herein, it will be obvious to those skilled in the art that variations may be made in the construction and relation of parts without departing from the spirit and scope of the invention described herein.

We claim:

1. A belt drive system comprising:
a belt having a belt body;
a tensile cord disposed in the belt body running along a longitudinal axis;
a plurality of belt teeth disposed on an outer surface of the belt body, a belt land disposed between adjacent belt teeth;
a driver sprocket attached to an engine crankshaft;
a driven sprocket;
the number of grooves on the driver sprocket being an integer multiple of the number of engine cylinders divided by two; and
between a point (A) where the belt engages the driver sprocket and the first immediately engaged belt tooth (A′) at least 50% of the belt land is in contact with the sprocket at a cylinder firing event.

2. The system as in claim 1, wherein the spacing of the belt teeth is such that at least two belt teeth are engaged with two belt grooves on the sprocket having the smallest angle of wrap.

3. The system as in claim 1, wherein a multiplier for the number of grooves on the driven sprocket as compared to the driver sprocket is an integer equal to or greater than two.

4. The system as in claim 1, wherein the belt tooth pitch (P) is determined by the formula P≦(π/180°)*(r)*(a)
were r=the radius of the smallest sprocket pitch diameter; and
α=angle of wrap of the belt about the smallest sprocket.

5. The belt drive system as in claim 1, wherein the belt further comprises a fiber loading.

6. The belt drive system as in claim 1, wherein the number of grooves on the driven sprocket being an integer multiple of the number of grooves in the driver sprocket.

7. A belt comprising:
an elastomeric body;
a tensile member disposed in the body parallel to a longitudinal axis;
a plurality of teeth disposed on the body in a direction transverse to the longitudinal axis, each tooth having a tooth area;
a land portion disposed between the teeth, the land portion having a land area;
the land area being greater than the tooth area wherein the ratio of the land area to the tooth area is in the range of approximately 1.50:1.0 to approximately 10.0:1.0; and
the land portion having a coefficient of friction for transmitting a torque by engagement with a sprocket surface.

8. The belt as in claim 7, wherein the coefficient of friction is in the range of approximately 0.30 to approximately 0.40.

9. The belt as in claim 7 further comprising a fiber loading.

10. A belt drive system for an internal combustion engine comprising:
a driver and driven sprocket;
a belt engaged between the driver and driven sprocket;
the belt comprising a body, transverse teeth having a pitch, a tensile cord embedded in the body disposed in an endless direction, and a land having a land area disposed between adjacent teeth;
the driver sprocket having a predetermined number of cooperating grooves corresponding to an integer multiple of the number of engine cylinders divided by two;
wherein engine cylinder firing timing determines the amount of belt land in contact with the driver sprocket on the belt tight side with respect to a point (A) during an engine cylinder firing event to minimize belt tooth loading; and
a point (A) where the belt engages the driver sprocket and the first immediately engaged belt tooth (A′) at least 50% of the belt land is in contact with the sprocket at a cylinder firing event.

11. A belt drive system comprising:
a belt having a belt body;
a tensile cord disposed in the belt body running along a longitudinal axis;
a plurality of belt teeth disposed on an outer surface of the belt body, a belt land disposed between adjacent belt teeth;
a driver sprocket attached to an engine crankshaft;
a driven sprocket;
the number of grooves on the driver sprocket being an integer multiple of the number of engine cylinders divided by two;
the number of grooves on the driven sprocket being an integer multiple of the number of grooves in the driver sprocket; and
a belt tooth and driver sprocket groove meshing frequency is not substantially distinguishable when superimposed upon an engine cylinder firing timing frequency.

12. The belt drive system as in claim 11 wherein:
engine cylinder firing timing determines the amount of belt land in contact with the driver sprocket on the belt tight side with respect to a point (A) during an engine cylinder firing event to minimize belt tooth loading; and
between point (A) where the belt engages the driver sprocket and the first immediately engaged belt tooth (A′) at least 50% of the belt land is in contact with the sprocket at a cylinder firing event.

13. The belt drive system as in claim 12, wherein the belt land area to tooth area ratio is in the range of approximately 1.5:1.0 to approximately 10.0:1.0.

14. The belt drive system as in claim 11, wherein the belt body further comprises a fiber loading.

15. The belt drive system as in claim 11, wherein the ratio of land area to tooth area is in the range of approximately 0.20:1.0 to approximately 0.09:1.0.

16. The belt drive system as in claim 15, wherein a load is transmitted by a frictional engagement between a tooth top surface and a pulley groove surface.

17. A belt comprising:
an elastomeric body;
a tensile member disposed in the body parallel to a longitudinal axis;
a plurality of teeth disposed on the body in a direction transverse to the longitudinal axis, each tooth having a tooth area;
a land portion disposed between the teeth, the land portion having a land area;
the land area being less than the tooth area wherein the ratio of land area to tooth area is in the range of approximately 0.20:1.0 to approximately 0.09:1.0; and
the tooth area having a coefficient of friction for transmitting a torque by engagement with a sprocket surface.
